(19) United States
(12) Patent Application Publication
(10) Pub. No.: US 2017/0291710 A1
(43) Pub. Date: Oct. 12, 2017

(54) Cloth Tray Cover For Tray Tables Found On Airplanes, Trains Or Cars, Having Assorted Pockets Of Diverse Utility, Including A Clear Sleeve Pocket On The Surface Of The Tray, An Adjustable Viewing Pocket For Electronic Devices, And A Collapsible Drink Holder For Use When The Tray Table Is In The Locked Position

(71) Applicants: Karla H. Barr-Perea, Huntington Beach, CA (US); Cynthia Allen Hofen, Mountain View, CA (US)

(72) Inventors: Karla H. Barr-Perea, Huntington Beach, CA (US); Cynthia Allen Hofen, Mountain View, CA (US)

(21) Appl. No.: 15/094,885

(22) Filed: Apr. 8, 2016

(51) Int. Cl. B64D 11/06; A45C 13/10; B60N 3/10; A47G 23/02; B61D 33/00; B60N 3/00; A45C 11/00; A45C 13/26

(52) U.S. Cl. CPC B64D 11/0636; A45C 11/00; A45C 13/103; A45C 13/26; A47G 23/0216; B64D 11/0638; B61D 33/0007; B60N 3/002; B60N 3/103; A45C 2011/003; A45C 2013/1015

(57) ABSTRACT

This embodiment of a cloth tray cover and its accessories is used on tray tables found on airplanes or trains, and with tray tables in some cars. The tray cover provides travelers with a protective germ barrier, as well as a way to organize personal items while traveling. The clear sleeve on the tray surface transforms the tray into a changeable activity board or a moisture barrier for reading material when drinks are served. The pockets of the tray cover accommodate both small and large personal items that travelers want to have handy. The tray cover can be sized and altered to fit any type of tray table for travel. The foldable drink holder provides a place to put one's drink when the tray table is up. The detachable viewing pocket provides a place to view an electronic device and can be adjusted to a passenger's preferred viewing position. It is also the storage case for the tray cover, the electronic device and the drink holder.

### CROSS-REFERENCE TO RELATED APPLICATIONS

This application claims the benefit of PPA Application No. 62/178,454 filed 2015 Apr. 10 by the present inventors, which is incorporated by reference.

### STATEMENT REGARDING FEDERALLY SPONSORED RESEARCH OR DEVELOPMENT

Not applicable

### REFERENCE TO A SEQUENCE LISTING, A TABLE, OR A COMPUTER PROGRAM, LISTING COMPACT DISC APPENDIX

Not applicable

Search
1. Elizabeth Davino and Stacy Weber
application Ser. No. 13/921,428
Airline Tray Cover
2. Norman Korpi
application Ser. No. 13/868,020
Airplane Tray CIP

### FIELD OF INVENTION

This invention relates generally to keeping one's personal space on an airplane clean and orderly by using a personal tray tablecloth, and more specifically it relates to covering the tray on an airplane while traveling, providing passengers with a protective barrier to the tray surface, as well as temporary storage pockets for personal items while traveling. In addition it provides a way to view an electronic device hands-free, or without having to sustain its weight, while in flight, and a place to put one's drink when the tray table is in the locked upright position.

### BACKGROUND OF THE INVENTION

Although travelers have long suspected that tray tables on airplanes are of questionable cleanliness, it has recently been determined that they are in fact one of the most unclean parts of an airplane seat. As airlines rush to disembark and then board passengers, there is no time between consecutive flights to lower each tray table and give it a good washing. More and more, germ transmission has been in the news, with the recent scare of the Ebola and Entero viruses, Swine and Bird Flu, as well as the annual cold and flu season viruses. The primary purpose of this invention is to provide a germ barrier that would minimize germ transfer from one airline passenger to the next, and additionally to facilitate the organization and accessibility of personal items, as well as personal entertainment to passengers while in flight.

### SUMMARY

This invention is a cover for an airplane tray table. It slips over and under the tray table, covering the top surface as well as the underside and all the side edges of the tray, and fits snugly to the tray with the ability to adapt to various tray sizes. For passengers on an airplane, it provides a germ barrier and a clean tray surface, as well as pockets that have a variety of purposes, including the facilitation of storing personal items and providing methods of entertainment while in flight; entertainment may include playing games, doing written activities, watching a movie or reading a book on an electronic device. Additionally, it provides a drink holder that attaches securely to the tray table, giving passengers a place to put their drink while the tray table is up.

### DETAILED DESCRIPTION

FIGS. 1 and 2 The Tray Cover, Lying Flat

One embodiment of this tray cover is illustrated in FIG. 1 (top view) and FIG. 2 (underside view). On the top side, (FIG. 1) which represents the side of the tray cover that would cover the upper tray surface, one can see a row of pockets (1) attached to the front flap of the tray cover; in this embodiment there are 3 pockets. These pockets are made by laying a second layer of fabric over the front flap of the body of the tray cover, in a shape and size similar to this flap. This second layer is sewn along the bottom and side edges of the flap, and then is divided into three pockets by sewing two vertical lines that divide this flap into thirds. The top edge of the middle pocket may be cut slightly lower (1a) to make it easier to turn the lock of the tray table when put up. When the tray cover is placed on the tray, these pockets hang over the front edge of the tray, and can accommodate a passenger's small personal items, such as pen, iPod, deck of cards, and eyeglasses. On the part of the tray cover that coincides directly with the tray surface, there is a clear sleeve (2) in the shape of a rectangle. Its points of attachment coincide with the back edge of the tray surface, with the side seams (5) under the tray when placed on the tray (seen in FIG. 2). This clear sleeve is made of a transparent material, in this embodiment a clear vinyl, because of its properties of being erasable, transparent and foldable. The sleeve opening (3) is aligned with the edge that is closest to the front row of pockets. A newspaper or other reading material can be slipped under this sleeve, and protected from moisture when the drinks come. Game sheets can also be inserted for repeated play with dry erase markers. An example of a game would be a Tic Tac Toe game sheet inserted into the clear sleeve, and two people can play, erase, and play again, using dry erase markers on the erasable sleeve surface.

The tray cover slips over and under a dropdown tray, such as an airplane tray table, covering it completely. It may be constructed of a combination of fabric cloths appropriate for each function, including but not limited to cotton, nylon, clear vinyl, or non woven fabric. This fabric would be cut in such a way that covers the entire tray surface when put on the tray, including the top and bottom surfaces, and all 4 side edges of the tray.

In FIG. 2 (underside view) the stretchy pocket (4) comes into view. The stretchy pocket is sewn to the top side of the tray cover along the side seams (5), and can stretch both ways to accommodate different widths of tray tables, as well as to provide sufficient space for personal articles such as iPad, books or toys. It is a double-layered stretchy material, such as power mesh, folded over to form a pocket. The upper two edges of this pocket are ⅓ wider than the folded lower edge, forming the shape of a trapezoid. Elastic is sewn into both upper edges, gathering them and resulting in the sides being pulled in. The stretchy pocket shape goes from trapezoidal to rectangular, with the gathered upper edges forming the stretchy pocket opening (31).

In this embodiment, the stretchy pocket, made of a suitable fabric such as power mesh, would cover the entire underside of the tray, and would be secured by sewing to two opposite side edges of the tray cover, called the side seams (5). The stretchiness of this mesh pocket would give this tray cover the ability to snugly fit the tray and adjust to different airplane tray sizes, and other tray tables, as well as provide storage and accessibility of a passenger's larger personal items, such as books or toys.

FIG. 3a—The Tray Cover Placed on the Tray

This illustration shows the tray cover placed on the tray, by slipping the tray between the top side of the tray cover and the stretchy pocket which would lie under the tray when put on. The row of pockets (1) are along the front edge of the tray. One can see the clear sleeve (2) on the surface of the tray, with a sheet of paper inserted (6) into the sleeve opening (3). The tray table is down (13). The tray table moves to the upright, locked position in the direction indicated by the arrow.

FIG. 3b—The Tray Cover on the Tray Table, in its Upright, Locked Position

This drawing shows the tray table in its upright, locked position (7), with the tray cover still on the tray. This position makes the stretchy pocket (4) and the side seams (5) of the tray cover visible. The row of pockets (1) are hanging along the top edge of the tray. The stretchy pocket is sewn to the body of the tray cover along the side seams (5).

FIGS. 4, 5, and 6—The Viewing Case that Converts to a Storage Case

FIG. 4—Viewing Case, Lying Flat, Interior View

In this drawing, the viewing case is introduced. The viewing case is an accessory that works with the tray cover. It is meant to provide a way for passengers to view a movie, surf the internet or read a book on an electronic device while traveling, with the tray table in the upright locked position, and without having to sustain the weight of the device with their hands. The viewing case also serves as a storage and carrying case for the electronic device, as well as for the tray cover and the drink holder (which has not yet been introduced). The viewing case has three sections. The bottom section is the clear pocket (15) that holds an electronic device. It is made by cutting a piece of transparent material such as clear vinyl, and layering it over the bottom section of the viewing case, made of any suitable fabric, such as nylon or cotton. The bottom and side edges are sewn to form a clear pocket. The size of this pocket should be big enough to accommodate a larger tablet like an iPad. The top edge is open for easy insertion of the electronic device, and has a means of closure, in this embodiment, using two rounded hook/loop fasteners (17) at equal intervals on the top edge. The corners are open corners (16), and may be diagonally cut or rounded. These corners are left open to provide easy access to the headset port and volume controls on the electronic device. The middle section of the viewing case contains an inverted storage pocket (19), which is of a similar size as the clear pocket in the bottom section. This pocket is made by attaching a second layer of fabric to the middle section at the top and side edges. The opening of this inverted storage pocket runs along its bottom edge, and is aligned with the middle seam (22) of the viewing case. It has a means of closure, in this case a zipper (20) running across horizontally along the bottom of the storage pocket. Along each side edge of this middle section, one can see the loop fastener strips (11) sewn and running vertically. On the top end of each of these strips is some type of grip clip, in this embodiment they are suspender clips (10), that are connected to the loop fastener strips (11). At the bottom of these loop fastener strips are two hook fastener tabs (21), one on each side, that are sewn into the middle seam (22). They are used for vertical adjustment of the clear pocket (15) to an optimal viewing position, fastening hook tab to loop strip, like the well-known Velcro fastener. Sewn into the top seam of the middle section, there are two elastic loops (12) that give the viewing pocket another way to attach, in this embodiment most useful for attaching to the posts of a car headrest, so that kids in the back seat can watch a movie while traveling. The top section of the viewing pocket is a closure flap (8), which is used to close the viewing case. It has a pocket (9) to store the suspender clips (10), as well as the elastic loops (12), to keep them out of the way when not in use. To make the closure flap and its pocket, the fabric is cut into a shape that is functional for this purpose, in this embodiment it is a rectangular shape. Another piece of fabric, of similar shape and size is layered on top of this fabric, and sewn along the top and side edges to form the flap pocket. This closure flap has a square of loop fastener (14) in the center, which is sewn onto the top layer of the pocket only, so that the pocket is not sewn shut. This square of loop fastener (14) corresponds to the square of hook fastener (24), which is on the back side of the clear pocket of the bottom section. Both the square of loop fastener (14) and the square of hook fastener (24) are part of the closure mechanism of the viewing case. The closure flap closes the viewing case into a storage and carrying case for traveling. (see FIG. 4)

FIG. 5—Viewing Case, Lying Flat, Exterior View

This illustration shows the viewing case, lying flat, with the exterior side in view.

Notice the handle (23) on this side, which is sewn into the middle seam (22), as well as a square of hook fastener (24) sewn in the bottom center on the opposite side of the clear pocket.

FIG. 6—Viewing Case, Closing Up As Storage and Carrying Case

Here you see the viewing pocket halfway closed, almost in the closed position as a storage case. The broken lines represent the suspender clips (10) and elastic loops (12) inside the flap pocket (9), and both hook (24) and loop (14) fasteners in view. The square of hook fastener (24) corresponds with the square of loop fastener (14) and are pressed and fastened together when the viewing pocket is in the fully closed position. The handle (23) is also in view. When fully closed, the viewing pocket forms a carrying case with handle, that can hold and carry the tray cover, the drink holder and the electronic device in the storage pocket.

FIGS. 7a, 7b, 7c and 7d-Viewing Case being put on the tray when the tray table is down, then the tray table will go up, and the Clear Pocket of the Viewing Case will be adjusted vertically.

FIG. 7a-Viewing Case, lying flat, interior view. The suspender clips (10) are attached to the loop fastener strips by sewing. In this illustration, they are out of the flap pocket (9), and the elastic loops (12) are inside this flap pocket. The elastic loops are represented by the broken lines. In this drawing, the open corners (16) of the clear pocket are cut diagonally, which is another embodiment of the clear pocket. The edges of the open corners are finished with a trim, such as bias tape, whether diagonal or rounded corners. The transparent material, such as clear vinyl, of the clear pocket does not interfere with the responsiveness of the touch screen of the electronic device. It also protects the screen, preventing fingerprints from gathering on the device's screen, and provides a secure place for the electronic device while traveling.

FIG. 7b-Viewing Case attaching to tray cover at edge of clear sleeve opening.

Here you see the suspender clips (10) of the viewing case being attached to the front edge of the clear sleeve opening (3) of the tray cover, on the surface of the tray. You can also see the loop fastener strips (11) running vertically along each side of the middle section, and the hook fastener tabs (21) ready to be grabbed and adjusted after the tray table is up. The arrow indicates the movement of the tray when put in the upright, locked position.

FIG. 7c-Clear Pocket of Viewing Case being adjusted upward using hook fastener tabs, with tray table in upright, locked position.

In this figure, you see the attached clear pocket (15) in the process of being adjusted upward for a better viewing position. It is being lifted by the hook fastener tabs (21), and will be placed along the loop fastener strips (11) at the optimal position for viewing. Notice the electronic device in the clear pocket, with the Netflix App on the screen. The loop fastener strips (11) along each outer edge allow the viewing pocket to be positioned at any vertical point along these two strips using the hook fastener tabs (21). The tray table is in the upright, locked position. (7)

FIG. 7d-Viewing Case in its highest viewing position, with hook fastener tabs fastened to loop fastener strips. Here you see the tray table in the upright, locked position (7), and the clear pocket in its highest viewing position. The row of pockets (1) is behind the clear pocket when attached in this way. The stretchy pocket (4) is also behind the clear pocket. The open corners (16) of the clear pocket are visible with the controls and ports of the electronic device accessible to the passenger. The movie has started.

FIG. 8—Viewing Case attached to posts of a car headrest. In this figure you see the viewing case attached to a car headrest, the headrest having been taken off momentarily to put the elastic loops (12) around the headrest posts (25) and then put back on. Notice a small electronic device having been placed in the clear pocket (15), with a book, The Grapes of Wrath, on the screen. When in this lowest position and connected to the tray cover on the tray table of an airplane or train, the electronic device rests nicely in a passenger's lap for reading or working. In this embodiment, the clear vinyl used does not interfere with the screen's responsive to touch.

FIG. 9—Viewing Case attached to side seams of tray cover. In this figure, the tray cover is on the tray table of an airplane or train, which is in the locked upright position (7). One can see the row of pockets along the top edge of the tray (1). The suspender clips (10) of the viewing case are grasping the side seams (5). These side seams are formed by sewing the sides of the stretchy pocket to the sides of the body of the tray cover. The advantage of attaching the viewing case to the side seams (5), is that the row of pockets hanging off the top of the tray are completely accessible. In this illustration, the clear pocket has been adjusted vertically only half way up, with the hook fastener tabs (21) fastened to the loop fastener strips (11) about halfway up on each side.

FIG. 10—Drink holder on tray in upright locked position. In this figure, you see the empty drink holder attached to the tray, which is in the upright, locked position (7). The drink holder is made of three separate panels. The rounded bottom panel has a rigid material inside, such as wood, which gives the drink holder a secure bottom to set a drink on. (27) The drink holder has a stretchy elastic strap (26) that is sewn to both sides of the middle panel above the drink well. It is used to hold securely taller drinks such as soda or juice cans. In this embodiment, the wall that forms the drink well (30) is attached to the rounded edge of the bottom panel (27), as well as the side edges of the middle panel (29), just under the elastic strap. The top square panel is not visible.

FIG. 11—Drink holder, with all elements visible. The three folding panels of the drink holder are now in view. They fold flat for compact storage. The rounded bottom panel (27) and the square top panel (28) are both rigid, with a thin piece of wood or other rigid material, sewn inside the two layers of cloth. The middle panel (29) and the wall that surrounds the drink to form the drink well (30), are both made of cloth, so are soft. To fold the drink holder, the middle panel (29) folds down over the rounded bottom panel (27), and then the square top panel (28) comes forward and folds over them both, ending up against the underside of the rounded bottom panel (27). The drink holder is roomy enough to accommodate the beverage cups typically used on airplanes, as well as any type of beverage can.

FIG. 12a-Drink holder being put on the tray. This figure shows how the drink holder is put on the tray. The square top panel (28) slips under the clear sleeve opening (3) of the tray cover, and then the tray is put into its upright locked position, in the direction indicated by the arrow.

FIG. 12b-Drink holder installed on the tray. This figure shows the end result of the drink holder installed on the tray. The tray is in the upright, locked position, (7) and the square top panel of the drink holder is hidden behind the tray, being held by the pressure between the tray and the seat back of the seat in front. The wall that forms the drink well (30) is surrounding a soda can, which is in the drink well. This soda can is held securely by the elastic strap (26). The row of pockets (1) hang along the top edge of the tray, with the cut-out (1a) shown. The stretchy pocket (4) is also visible.

### ADVANTAGES

The tray cover is a protective cover, similar to a toilet seat cover in public bathrooms. It provides a barrier between the tray surface and the passenger, protecting a passenger from germs already on the surface, but since the passenger using the tray cover takes the majority of their own germs with them when they leave, it also protects the next passenger to use that tray table. Since trays are not cleaned between consecutive flights, this tray cover would also help to keep planes cleaner and perhaps impede flu and cold viral transmission while traveling.

The tray cover's pockets also give passengers a way to organize themselves while flying, hopefully minimizing the need to access their carryon baggage and disturb other passengers while in flight. There's a place for everything one might want to keep handy during flight. It helps all passengers, both adults and children, create their own space, with all their favorite things and snacks close at hand.

With the tray table turned into a changeable game board or white board, there's always something to do that's right in front of the child or adult, and these games can be played with traveling companions. The clear protective sleeve provides storage for game sheets, as well as a quick, moisture-resistant place to keep a newspaper or other reading material when the drinks are served. The erasability of the sleeve permits the repeated play of game sheets with dry erase markers.

The viewing case gives passengers a place to store their electronic device while traveling, and a way to watch a movie or surf the internet with the tray table up, either handsfree, or without having to sustain the full weight of the device. It also keeps the device out of reach of small children, and protects the screen from fingerprints. And when you arrive to your destination, you have a quick and easy storage case for the tray cover, drink holder and tablet, that can be easily slipped into your carryon.

The drink holder gives passengers a way to put their tray tables up before they're finished with their drinks. They can put the tray table up, having more room for their legs, and leisurely sip their drink, with a place to set it down. The elastic strap is great for securing beverage cans. This drink holder also packs easily, since it folds flat. It can easily be slipped into a purse or the pocket of a carryon, or stored in the viewing case. It is easily adapted to most tray thicknesses and drink sizes.

### Other Embodiments

1. The simplest embodiment of this tray cover would be a cover more like an envelope, that would encase the tray. It could be made of non woven or nylon fabric, and would encase the tray completely, both the top, and underside surfaces, and all of its side edges, like an envelope, with no other purpose than to provide a clean tray surface for passengers. It would slip over the tray from the front edge toward the back, and be fastened with a hook/loop fastening system under the tray, with the back flap attaching to the underside.

2. Another embodiment would be for trays that come sideways out of the arm rest, and in such a case, the tray cover would have to be constructed with the slip-on opening coming from the side, like a pillowcase, and the stretchy pocket being sewn to the body of the tray cover along front and back seams instead of side seams. The stretchy pocket would still have its opening along the front edge of the tray, behind the row of pockets. It would be attached to the tray cover by sewing the bottom layer of the stretchy pocket to the front edge, and the folded bottom of the stretchy pocket to the tray cover's back flap. The size of this stretchy pocket would have to be modified to adapt to this configuration. There could be another row of pockets along the side edge opposite the slip-on opening, that would need a closure mechanism like a zipper. A larger pocket would be sewn into the back side seam with the stretchy pocket bottom, and would hang from the back of the tray. This hanging pocket would only be accessed when the tray table is in the upright, locked position.

3. Another embodiment would be the tray cover with pockets running along the sides and back edges of the tray, using a closure mechanism such as zipper, so that items would not fall out of these pockets when the tray table goes up. A large pocket could be added to the back edge of the tray, which could only be accessed when the tray table is up. It may or may not be a stretchy pocket.

4. An additional embodiment of the viewing case, instead of being detachable like the embodiment explained, could be permanently attached to the tray cover at the side seams under the tray, attached at two upper points of the viewing case, one on each side, using some kind of stretchy elastic attachment mechanism, to retain the stretchy adaptability of the tray cover to different tray sizes. The clear pocket could still be adjusted vertically up and down. The other points of attachment would be inside the storage pocket of the viewing case, sewn under the loop fastener strips, and this storage pocket would have an opening on top edge instead of at the middle seam of the middle section, where the tray cover and drink holder could be pulled in and stored. There still could be a zipper closure of this pocket, and then the closure flap would finish the job of closing the viewing case. The handle would be in the same place, sewn into the middle seam on the exterior side.

5. Another embodiment of the clear pocket for the electronic device could be the addition of an open frame consisting of two vertical open slips, one running along on each side edge and in front of the clear pocket, where the device can either be slipped behind the clear front layer, or could be slipped in front of the clear pocket, being held by these two side frame pieces, giving the passenger the viewing option of a bare, uncovered screen. There would be closure flaps on each lateral side of the frame pieces to close the pocket once the device is inserted. The closure flaps would be secured with hook/loop tabs or some other appropriate closure mechanism. The sides would be open on the corners to provide access to the controls and ports of the device. The top and bottom edge of the clear pocket would be sewn all the way across. The frame would be fitted to a particular screen, so is sized for a specific electronic device, such as an iPad. Smaller devices could be slipped behind the clear pocket.

6. Another embodiment of the drink holder would be one in which the drink holder was permanently attached to the tray cover. It would be sewn to the back of one of the smaller pockets in the row of pockets. The square top panel of the drink holder would still be needed for stability, but could be folded toward the front and stored in this smaller pocket while the tray table is down. When the passenger puts the tray table up, the square top panel would be flipped back and straddle the top edge of the tray before it is locked in its upright position.

### BRIEF DESCRIPTION OF DRAWINGS

FIG. 1—Tray cover, lying flat, top side visible.

FIG. 2—Tray cover, lying flat with the underside visible.

FIG. 3a—Tray cover when placed on an airplane tray table with tray down.

FIG. 3b—Airplane tray table in the upright locked position with tray cover on—Here

FIG. 4—Viewing Case, lying flat, with the interior side in view.

FIG. 5—Viewing Case, lying flat, with the exterior side in view.

FIG. 6—Viewing Case halfway closed, converting to storage case.

FIG. 7a—Viewing Case, lying flat, interior view.

FIG. 7b—Viewing Case attaching to tray cover at edge of clear sleeve opening.

FIG. 7c—Clear Pocket being adjusted upward using hook fastener tabs, with tray table in upright, locked position.

FIG. 7d—Clear Pocket in its highest viewing position, with hook fastener tabs fastened to loop fastener strips.

FIG. 8—Viewing Case attached to posts of a car headrest.

FIG. 9—Viewing Case attached to side seams of tray cover.

FIG. 10—Drink holder on tray in upright locked position.

FIG. 11—Drink holder, with all elements visible.

FIG. 12a-Drink holder being put on the tray.

FIG. 12b-Drink holder installed on the tray.

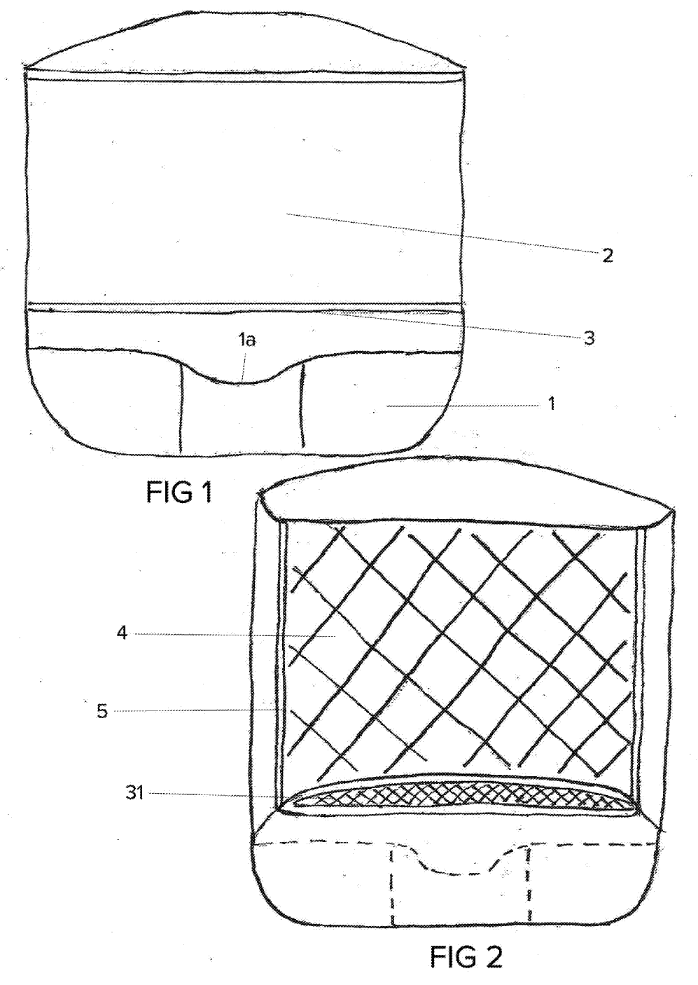

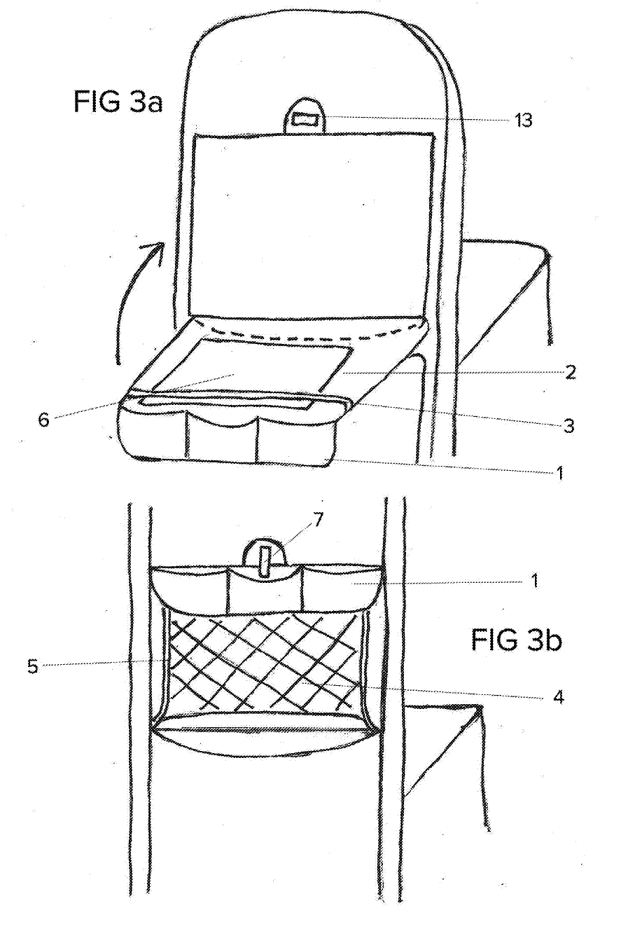

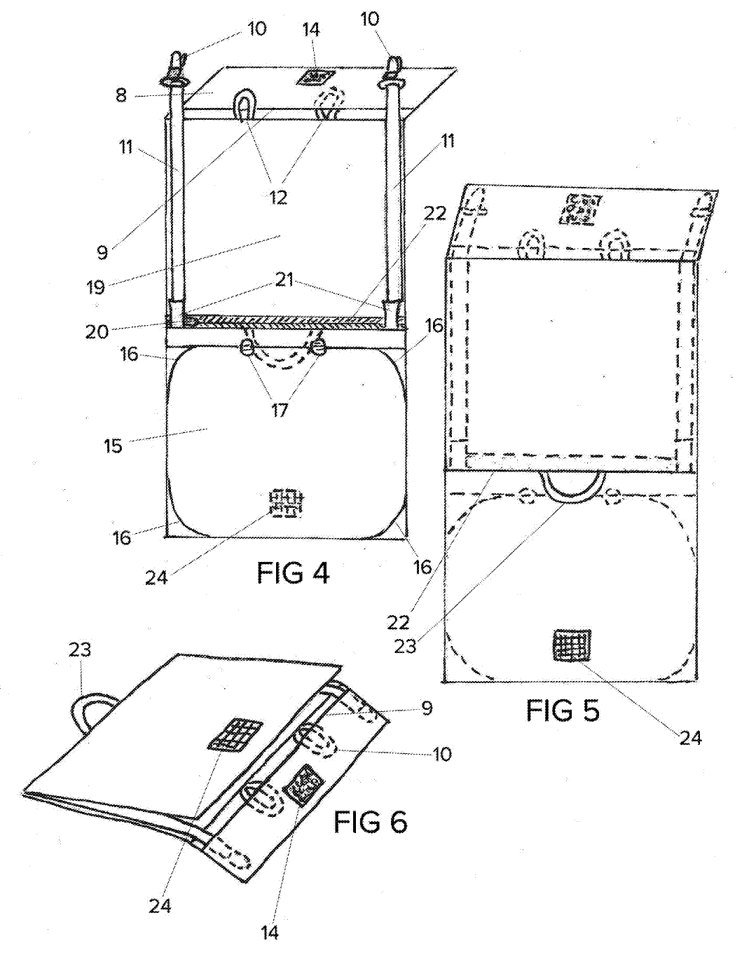

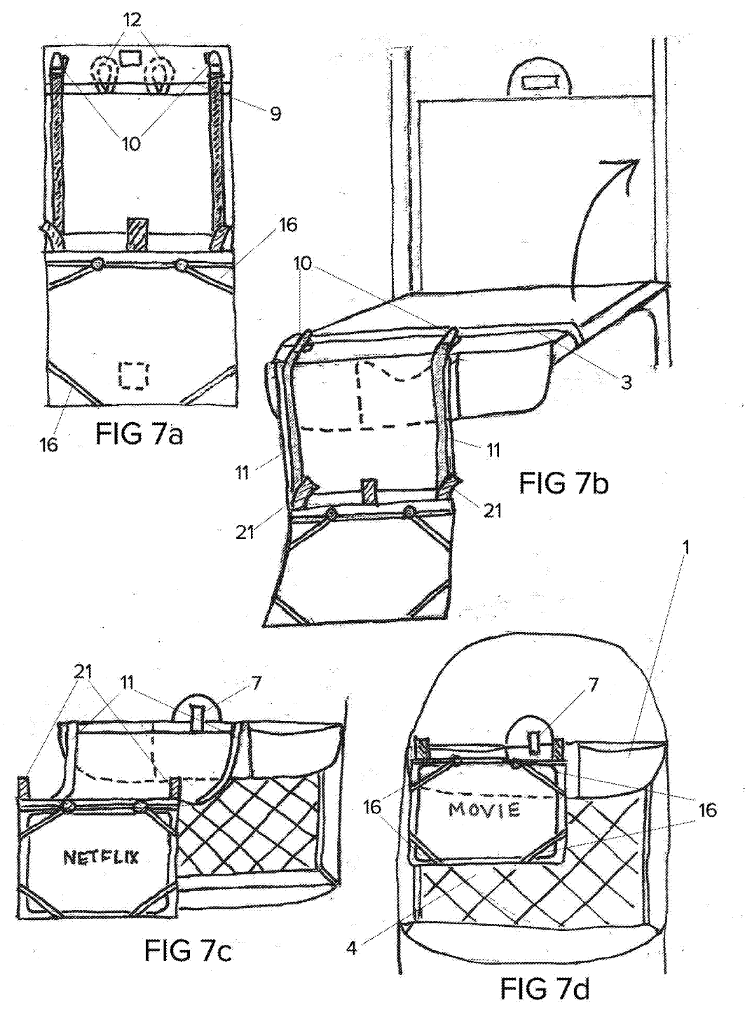

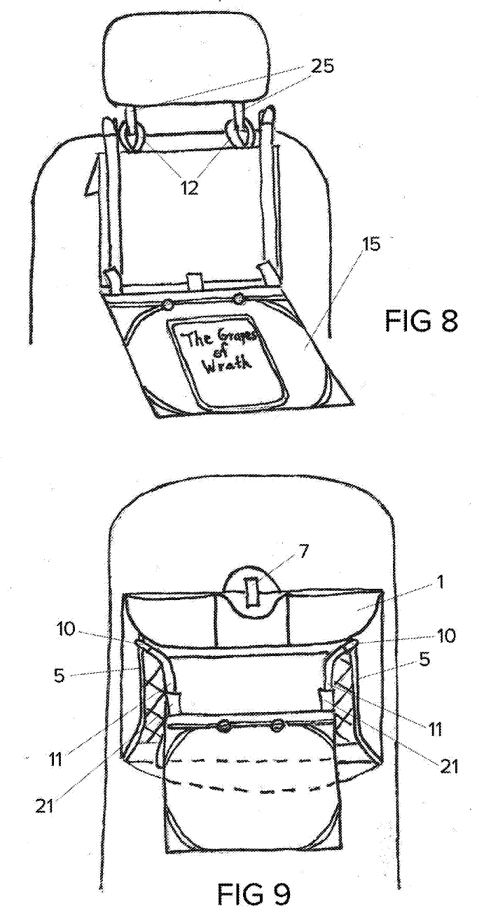

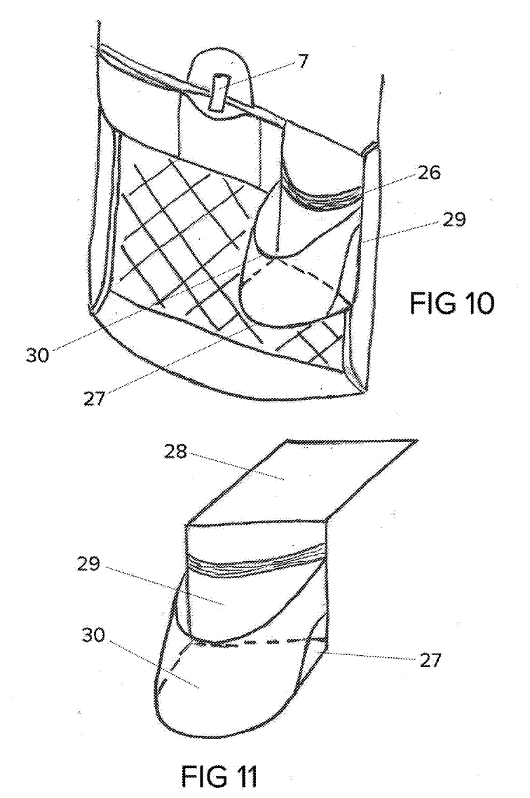

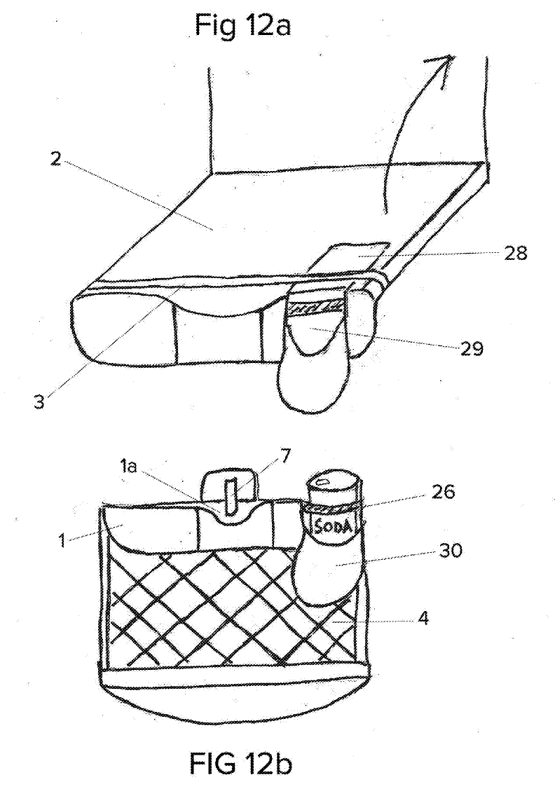

### LIST OF REFERENCE NUMBERS

1. row of pockets
1a cut-out of top edge of middle pocket
2. clear sleeve
3. sleeve opening
4. stretchy pocket
5. side seams
6. sheet of paper
7. tray table lock engaged
8. closure flap
9. flap pocket
10. suspender clips
11. loop fastener strips
12. elastic loops
13. tray table lock disengaged
14. square of loop fastener
15. clear pocket
16. open corners
17. rounded hook/loop fasteners
18. middle section
19. storage pocket
20. zipper
21. hook fastener tabs
22. middle seam
23. handle
24. square of hook fastener
25. headrest posts
26. elastic strap
27. rounded bottom panel
28. square top panel
29. middle panel
30. wall that forms the drink well
31. stretchy pocket opening

What is claimed is:

1. A cloth tray cover made to fit snugly over tray tables found in airplanes, trains and some cars, that when slipped over said tray table, effectively covers all of said tray table surfaces completely, including the topside, the underside and the four lateral sides of the tray, performing the function of protecting a passenger from direct contact with said tray table surfaces and reducing said passenger's exposure to germs left from the last passenger, said cloth tray cover comprising a tray cover body joined with a plurality of pockets of varying sizes, shapes and functionalities, said plurality of pockets achieving the result of said passenger having storage to keep personal items close-at-hand, reducing said passenger's need to access carryon luggage, and facilitating said passenger's comfort, convenience, organization, and entertainment, while traveling, comprising
a. Said tray cover of claim 1, having a row or rows of smaller pockets, that may be open, drop-in pockets, or may have any appropriate means of closure such as zipper, said row or rows of smaller pockets aligning with and hanging from one or more tray edges when said tray cover is put on said tray table, said small pockets made of any suitable size or shape and with any appropriate fabric for their function, including but not limited to nylon or cotton, said small pockets performing the function of storing and keeping handy a traveler's small personal items while traveling, such as lotion, eyeglasses, playing cards, pen or iPod,
b. Said tray cover of claim 1, having an erasable, protective clear sleeve that overlays the top surface of said tray table when said tray cover is put on, said clear sleeve being made of a transparent, waterproof, foldable and erasable material such as clear vinyl film, cut in a rectangular shape and sewn to said tray cover body along the back edge and side seams of said tray cover, forming said clear sleeve, having a sleeve opening that aligns with the front edge of said tray table, said clear sleeve having the functionality of converting said tray table into a game board or white board for kids, by insertion of game and activity sheets, or plain white paper into said clear sleeve opening, achieving the result of said kids being able to draw, doodle, play games, erase and play again, using dry erase crayons or markers while traveling, said clear sleeve performing the additional function of housing and protecting documents or other reading material such as newspapers, when drinks are served,
c. Said tray cover of claim 1 having a large, stretchy pocket that covers the underside of said tray table when said tray cover is put on, said stretchy pocket being made of any stretchy fabric appropriate for this purpose such as stretchy power mesh, said stretchy pocket being formed by folding over this stretchy fabric to make a double-layered stretchy pocket, cut in the shape of a trapezoid with its two upper edges being wider than said stretchy pocket's folded bottom, said two upper edges being gathered with elastic to achieve the result of a stretchy pocket opening with the same width as its pocket bottom, with said stretchy pocket's sides attached to said tray cover at said tray cover's side seams, said stretchy pocket performing the function of providing storage for a passenger's larger personal items such as books, snacks, diapers or toys, said stretchy pocket additionally achieving the result of being able to accommodate different tray table sizes with its stretchiness.

2. Said tray cover of claim 1 having a cloth drink holder for use when said tray table is in the upright, locked position, that may or may not be made of a water-resistant fabric, such as nylon, and may or may not be releasable from said tray cover, said drink holder comprised of three connected panels of equal size, said size being sufficiently roomy to accommodate a normal sized drinking cup, with space around said cup for easy grabbing, said three panels sewn together and having the ability to fold flat, one panel on top of the other, achieving the result of making said drink holder very compact and easy to store, the two outer panels of said three panels, known as the rounded bottom panel and the square top panel, containing a thin, flat rigid material, such as wood, said rigid material having an approximate thickness of no more than ⅛ inch, that is sewn inside said rounded bottom panel and said square top panel, achieving the result of said two panels being rigid, said drink holder having a protective cloth wall sewn into each lateral side of the middle panel as well as the front and side edges of said rounded bottom panel of said drink holder, said cloth wall being cut in any appropriate size or shape that forms a cavity or drink well, performing the function of holding a plastic or paper cup, or beverage can securely, with space enough for a passenger to easily grab their drink, with said drink sitting on said rounded bottom panel and surrounded by said wall that forms the drink well, which is soft and collapsible, said drink holder additionally having a stretchy strap sewn into said lateral sides of said middle panel and above said drink well, that performs the function of securing taller drinks, like soda cans by belting them in securely at a higher point on said cans, said drink holder attaching to said tray table by means of said square top panel of said drink holder slipping under said sleeve opening of said clear sleeve of tray cover in claim 1, said square top panel straddling the top edge of said tray table when locked in its upright position, and held securely using the rigidity of said square top panel being pressed between the seat back and said tray table, achieving the result of having a place to put one's drink with said tray table in the upright, locked position.

3. Said tray cover of claim 1 having a viewing and storage case for a passenger's electronic device, that may or may not be releasable from said tray cover, and is comprised of three sections, which include the clear pocket for viewing, the middle section which has a large storage pocket, and the closure flap, said clear pocket being constructed with a transparent, waterproof material such as clear vinyl film, layered over and sewn to the bottom section of the viewing case, for the purpose of making a pocket for viewing, as well as manipulating and protecting a tablet's screen, said clear pocket is cut in a generally rectangular shape with corners that may be rounded or cut on a diagonal, said clear pocket is sewn to said viewing case along its bottom and side edges, but leaving the corners of said clear pocket open, achieving the result of providing easy access to the controls and plug-in ports of said electronic device, said clear pocket having the top edge open, achieving the result of easy insertion or removal of electronic device, said viewing case may or may not be detachable from said tray cover, that in another embodiment may be attached permanently to said tray cover, joining at said side seams on the underside using a stretchy material to retain said tray cover's adaptability to different tray sizes, said viewing case in this embodiment may be attached and detached at various places on said tray cover, by means of clips or any other mechanism that can securely grab an edge of fabric, such as said sleeve opening in claim 3, or the bottom of said row of small pockets of claim 2, or at said side seams of said tray cover, and achieves the result of said viewing pocket hanging from said tray table when locked in an upright position, for the purpose of hands-free viewing of a movie or show and providing a secure place for said electronic device while traveling, said viewing case also having the ability to be adjusted vertically using a hook/loop system, or any other appropriate fastening mechanism, running along each outer edge, to achieve the result of an optimal viewing position for different-sized travelers, and of a passenger being able to read or work handsfree with said electronic device resting in said passenger's lap, said viewing case performing the additional function of being a carrying and storage case for said tray cover, said electronic device, and said drink holder, by means of an additional storage pocket built into said viewing case, that can be securely closed using a zipper or other appropriate closure mechanism, and said viewing case having a carry handle sewn into said middle seam of its exterior side.
